(19) United States
(12) Patent Application Publication
(10) Pub. No.: US 2014/0242462 A1
(43) Pub. Date: Aug. 28, 2014

(54) CORROSION RESISTANCE METALLIC COMPONENTS FOR BATTERIES

(71) Applicant: Treadstone Technologies, Inc., Princeton, NJ (US)

(72) Inventor: Conghua WANG, West Windsor, NJ (US)

(73) Assignee: Treadstone Technologies, Inc., Princeton, NJ (US)

(21) Appl. No.: 14/189,223

(22) Filed: Feb. 25, 2014

Related U.S. Application Data
(60) Provisional application No. 61/769,197, filed on Feb. 26, 2013.
(60) Provisional application No. 61/798,737, filed on Mar. 15, 2013.

(51) Int. Cl. H01M 4/04; H01M 4/66

(52) U.S. Cl. CPC H01M 4/0402; H01M 4/661; H01M 4/0419
USPC 429/218.1; 427/58; 427/448; 427/123; 427/125

(57) ABSTRACT

Methods for coating a metal substrate with electrically conductive dots or splats of active materials for use in battery applications that improve the corrosion resistant metallic component electrode activity, or electrical conductivity of those components at reduced or lower costs.

### CROSS-REFERENCE TO RELATED APPLICATIONS

The present application claims priority to U.S. Provisional Application Ser. No. 61/769,197, filed on Feb. 26, 2013, and U.S. Provisional Application Ser. No. 61/798,737, filed on Mar. 15, 2013, which are incorporated herein by reference in their entireties.

### FIELD

The present invention relates to the design and fabrication methods for high performance battery electrodes and current collectors, more particularly, to the design of such metal components and the use of cost-effective processing methods for depositing small amounts of active materials as the active points for the electrode and current collector in batteries. In addition, a method of using the electrode for a high performance battery is also disclosed.

### BACKGROUND

An electrode and current collector are essential components in all kinds of batteries. In general, these components have to be electrically conductive and corrosion resistant for the battery operational conditions. In addition, the electrode also has to be electrochemically active for electrode reactions.

Common batteries use metal or graphite as the electrode and current collector materials. These materials are electrically conductive in body and surface in the specific battery operational conditions, and the chemical environment in the battery will not cause significant corrosion of the electrode. Examples of these types of electrodes include nickel in nickel-cadmium and nickel hydride batteries, and lead in lead acid batteries. Typically, the operational conditions of these batteries are not aggressively corrosive. Alternatively, special engineering designs are used to enable the application of these components in the battery. Therefore, it is not challenging to have suitable electrode materials for these batteries.

However, the operational conditions of more advanced batteries are more corrosive because e.g., they include/use more acidic conditions or high charge/discharge voltages. Therefore, these batteries need more corrosion resistant materials for the electrode(s) and current collector(s).

One example of the advanced battery is the soluble lead acid battery. The typical solution is 1-2 M H₂CH₃SO₃ acid with 1-2 M PdCH₃SO₃ The battery charge voltage could be higher than 2.0V. The acidic conditions and the high voltage make it challenging to use graphite as the electrode, because graphite will become oxidized during the charging period.

Another example of the advanced battery is the metal-halide battery. The cycle life of the metal electrode is limited. One way to extend the cycle life of the battery is to completely dissolve the metal from the electrode by reverse charging. Therefore, the electrode has to have excellent corrosion resistance at high potentials. A typical graphite electrode cannot be used in this type of battery.

However, most corrosion resistance metals depend on the surface oxide scale for corrosion protection. This oxide scale is not, typically, electrically conductive, and lacks electrode reactive activities. It will lead to the low energy efficiency of the battery.

The common practice in the industry is to coat a metal plate surface with a layer of precious metal for the electrode reaction activities, and electrical conductivity. This type of electrode is widely used in electrical plating industry, but is too expansive for battery applications.

Therefore, there is a need for technologies that can provide low cost electrodes and current collectors for advanced battery applications.

### BRIEF DESCRIPTION OF THE DRAWINGS

FIG. 1 is a schematic cross-sectional view of a structure including multiple metal dots deposited on the surface of a corrosion-resistant metal substrate, according to an embodiment disclosed herein.

FIG. 2 is the SEM picture of silver dots on a Ti plate surface.

FIG. 3 is the SEM picture of gold dots on a titanium plate surface.

FIG. 4 illustrates is a comparison of the charge and discharge curve of a soluble lead acid battery that uses the disclosed titanium (Ti) electrodes with gold splats and a soluble lead acid battery that uses a standard graphite electrode.

FIG. 5 is the picture of the titanium (Ti) plates with gold splats that are used as the electrodes for a soluble lead acid battery test.

FIG. 6 is the I-V curve of HBr—Br₂ battery using niobium metal plates with ruthenium splats as current collectors.

FIG. 7 is the SEM picture of a porous Ti plate with Pt dots on the surface.

### DETAILED DESCRIPTION

Various embodiments are described below for methods in which active materials can be deposited on metal substrates for use in battery applications that improve the electrode activity or electrical conductivity and corrosion-resistance of those electrodes or current collectors, at reduced or lower costs. Such embodiments can be used in batteries having metallic based components, such as a metal-halide battery, an iron battery, a lead acid battery, or vanadium battery, for example.

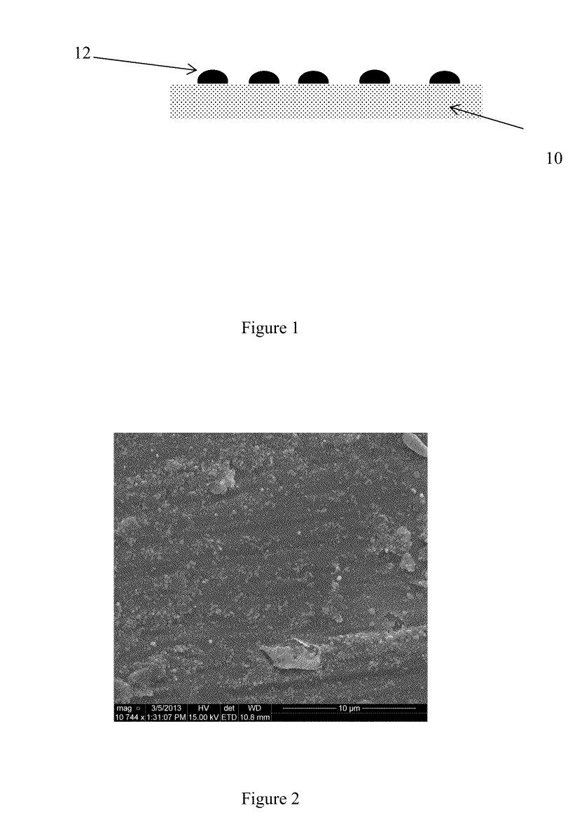

FIG. 1 is a schematic cross-sectional view of a structure including multiple metal dots 12 deposited on a surface of a corrosion-resistant metal substrate 10, according to an embodiment disclosed herein. The metal dots 12 can be used as active points for electrode reaction, or electrical conduction, that have high electrode reaction activity, or electrical conductance, and the corrosion resistance for the application. In one example, the corrosion-resistant metal substrate 10 can include titanium, niobium, zirconium, tantalum, nickel, and/or an alloy made of any one of such materials. In another example, the corrosion-resistant metal substrate 10 can include low-cost carbon steel, stainless steel, copper, and/or aluminum, and/or an alloy made of any one of such materials. In yet another example, the corrosion-resistant metal substrate 10 can include iron, chromium, or nickel, or an alloy made of any one of such materials.

In one embodiment, the corrosion-resistant metal substrate 10 can include a corrosion-resistant coating layer disposed on a surface of a metal substrate and having better corrosion resistive properties than the metal substrate. The corrosion-resistant coating layer can be deposited on the metal substrate using a vapor deposition process (e.g., physical vapor deposition or chemical vapor deposition), electrical plating, metal cladding, or other suitable method a on lower cost substrate material. In this case, the metal substrate would actually have multiple layers, instead of the single layer shown in FIG. 1.

The metal dots 12 can include precious metal particles that are bonded onto the surface of the corrosion-resistant metal substrate 10. The metal dots 12 should have high electrode reaction activity, electrical conductivity, and corrosion resistance. The dots 12 can include precious metal such as e.g., silver, gold, palladium, platinum, iridium, and/or ruthenium.

In one example, the material used for the metal dots 12 can have a diameter of 0.005 μm to 50 μm. In some embodiments, the metal dots/splats 12 comprise platinum, and the diameter of the dots can have a range of e.g., 5 nm-10 nm, 10 nm-50 nm, 10 nm-100 nm, 10 nm-20 μm, 1 nm-0.5 μm, 20 nm-0.5 μm, 100 nm-0.5 μm, 20 nm-1 μm, 100 nm-1 μm, 0.5 μm-5 μm, 1 μm-20 μm, or 10 μm-50 μm.

In one example embodiment, the distance between the dots 12 are between 0.05 μm to 500 μm. In some embodiments, the metal dots 12 comprise ruthenium, and the distance between the dots can be in the range of e.g., 50 nm-100 nm, 100 nm-20 μm, 0.1 μm-0.5 μm, 100 nm-1 μm, 1 μm-50 μm, 10 μm-200 μm, 100 μm-500 μm.

In one example. the thickness associated with the metal dots 12 is in the range of about 1 nanometer (nm) to about 50 microns (μm). In some embodiments, the metal dots 12 comprise gold, and the thickness of the dots can be in the range of e.g., 1 nm-5 nm, 1 nm-10 nm, 10 nm-50 nm, 10 nm-100 nm, 10 nm-20 μm, 1 nm-0.5 μm, 20 nm-0.5 μm, 100 nm-0.5 μm, 20 nm-1 μm, 100 nm-1 μm, 0.5 μm-5 μm, 1 μm-20 μm, 10 μm-50 μm, with a range of 10 nm-50 μm being desirable in certain embodiments.

The electrically-conductive metal dots are not limited to a perfectly round shape. The dots could be irregularly shapes, long strips, oval shaped, donut-like shaped, etc. In some embodiments, some dots can be overlapped with others.

In one embodiment, the metal dots 12 can be deposited on both sides of the metal plate 10. The resultant plate can be used as the mono-polar or bipolar electrode in batteries, depending on the battery design.

The electrically-conductive metal dots 12 can be deposited on the corrosion-resistant metal substrate 10 through a thermal or a cold spray process, for example.

The electrically-conductive metal dots 12 can be deposited on the corrosion-resistant metal substrate 10 through an electrical plating process, for example.

The electrical-conductive dots 12 can be deposited on the corrosion-resistant metal substrate 10 through a physical vapor deposition (PVD) process, for example.

The electrically-conductive dots can be applied on the metal surface by mechanical means, such as sand blasting, or brushing.

The metal substrate 10 can be a solid plate or a porous plate. The shape of the plate 10 could be flat, it could include machined channels, or it could be stamped to a corrugated shape.

Thermal spraying techniques provide a low-cost, rapid fabrication deposition technique that can be used to deposit a wide range of materials in various applications. In a typical thermal spraying, materials are first heated to, for example, temperatures higher than 800 degrees Celsius (° C.), and subsequently sprayed onto a substrate. The material can be heated by using, for example, a flame, a plasma, or and electrical arc and, once heated, the material can be sprayed by using high flow gases. Thermal spraying can be used to deposit metals, ceramics, and polymers, for example. The feeding materials can be powders, wires, rods, solutions, or small particle suspensions. The dots deposited by thermal spray are commonly called “splats” in the industry.

There are various types of thermal spraying techniques that can be used for material deposition, such as those using salt solutions, metal particle suspensions, dry metal particles, metal wires, or composite particles having a metal and a ceramic. One type of thermal spraying is cold gas dynamic spraying. In cold gas dynamic spraying, the material is deposited by sending the materials to the substrate at very high velocities, but with limited heat, typically at temperatures below 1000 degrees Fahrenheit (° F.). This process, however, has the advantage that the properties of the material being deposited are less likely to be affected by the spraying process because of the relatively low temperatures.

In this embodiment, metal silver dots 12 can be thermally sprayed onto the top surface of the corrosion-resistant metal substrate 10 by thermally spraying a silver nitrate salt solution. The solution can include a twelve point five percent (12.5%) in weight of silver nitrate in water, for example. The solution is sprayed by a flame spray to deposit the silver dots on a titanium substrate. A scanning electron microscopy (SEM) picture of silver dots on a titanium substrate is shown in FIG. 2. This titanium plate with silver dots can be used e.g., as the negative electrode in zinc-bromine batteries.

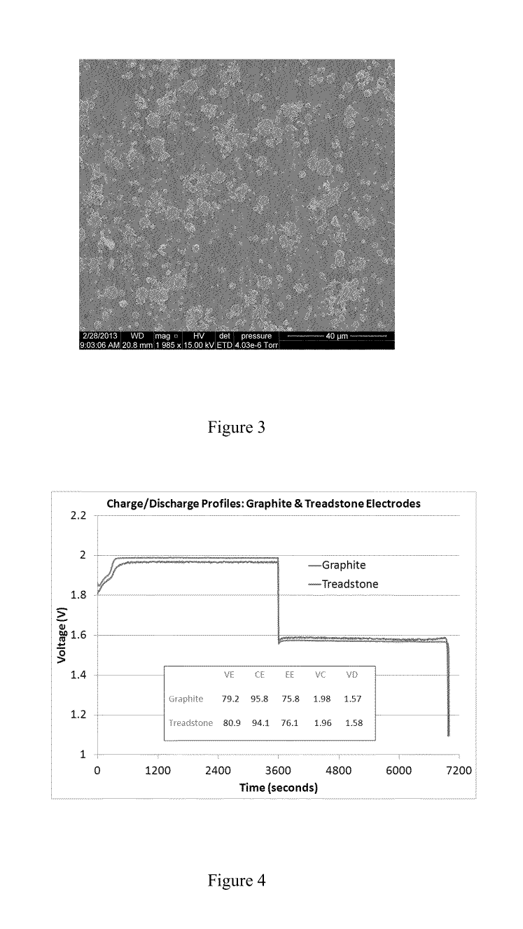

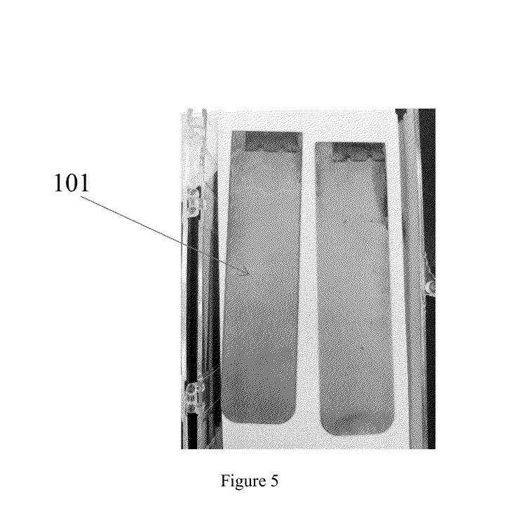

In one example, the metal particle suspension can include a mix having 2.25 grams (g) of gold powder (at about 0.5 μm in diameter), 80 g of ethylene glycol, and 0.07 g of surfactant (PD-700 from Uniquema) and then dispersed for 15 minutes using an ultrasonic probe. Then, the slurry is fed to the flame spray nozzle and thermally sprayed on the titanium substrate to deposit gold dots on the Titanium plate. FIG. 3 shows the SEM picture of the gold dots on the Ti plate surface. This titanium plate with gold dots can be used as the electrodes in a soluble lead acid battery. FIG. 4 shows a comparison of the charge/discharge curves of the electrodes comprising a titanium plate with gold dots (marked as Treadstone) and the standard graphite electrodes (marked as Graphite) in H₂CH₃SO₃—PbCH₃SO₃ solutions as a lead acid battery. The comparison shows that the cell with the titanium plate with gold splats as the electrodes has a higher energy efficiency (EE) than that of standard graphite electrodes. FIG. 5 shows a picture of the titanium (101) (with gold splats) electrode used in the experiment.

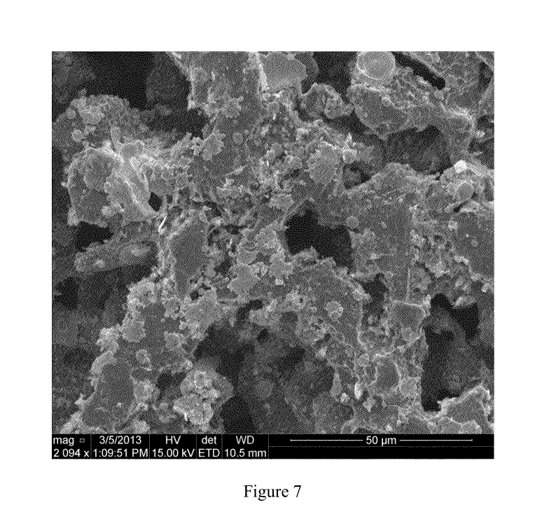

In one example, the metal particle suspension can include a mix having 2.25 grams (g) of platinum powder (at about 1 μm in diameter), 80 g of ethylene glycol, and 0.07 g of surfactant (PD-700 from Uniquema) and then dispersed for 15 minutes using an ultrasonic probe. Then, the slurry is feed to the flame spray nozzle and thermally sprayed on the porous titanium plate to deposit platinum dots on the Titanium plate. FIG. 7 shows the SEM picture of the Pt dots on the Ti plate surface. This porous titanium plate with platinum dots can be used e.g., as the electrodes in all-iron flow battery.

In one example, the metal particle suspension can include a mix having 5 grams (g) of ruthenium powder (at about 0.2 μm in diameter), 80 g of ethylene glycol, and 0.07 g of surfactant (PD-700 from Uniquema) and then dispersed for 15 minutes using an ultrasonic probe. Then, the slurry is feed to the flame spray nozzle and thermally sprayed on the niobium plate to deposit ruthenium dots on the niobium plate. This niobium plate with ruthenium dots can be used e.g., as the electrodes in all-iron flow battery.

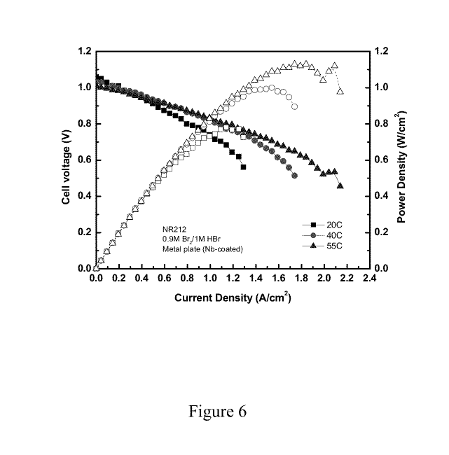

In one application disclosed herein, ruthenium particles are deposited on a niobium substrate, in the form of ruthenium splats, by a thermal spray process. The plate can be used as the current collector in HBr—Br₂ battery, where porous carbon felts are used as the electrode for electrode reactions. The ruthenium splats work as the electrical contact of the plate with the graphite electrode, to collect electrical current from and to the electrode. FIG. 6 shows the I-V curve of a HBr—Br₂ battery with the niobium plate with ruthenium dots as the current collector, operating at 20° C., 40° C. and 55° C., in 0.9M Br₂+1M HBr solution.

In one example, the titanium plate is used as the substrate for the electrode. The plate has a native oxide layer on the surface. Then, the plate is rapidly cleaned by sand blasting that removes the native oxide layer on partial areas of the plate surface, in the form of isolated small points. Then, gold is plated on the sand blasted small points. The gold cannot be plated on the rest of the plate surface due to the native oxide layer. This titanium plate with gold dots can be used as the electrode for all-iron battery.

In one application disclosed herein, iridium-ruthenium alloy particles are deposited on a titanium (Ti) substrate, in the form of iridium-ruthenium alloy splats, by a thermal spray process. These splats are used as the active electrode reaction points for the electrode of a soluble lead acid battery.

In another application, ruthenium particles are deposited on a Ti substrate, in the form of ruthenium splats, by a thermal spray. These ruthenium splats can be used as the reaction points for the electrode reaction in a zinc-halogen battery. The titanium with ruthenium splats can be a solid piece, or it can be in the form of mesh or screen. In one specific application, the ruthenium splats can be first deposited on a titanium foil. Then, the foil is used to make an extended titanium foil and formed into a corrugated 3-D structure for the battery solution flow, and high surface area.

In a further application, gold particles are deposited on a titanium (Ti) substrate, in the form of gold splats, by a thermal spray process. These gold splats are used as the active electrode reaction points for an electrode of an all iron battery.

In yet a further application, platinum (Pt) particles are deposited on a titanium (Ti) mesh, screen or porous plate, in the form of Pt splats, by a thermal spray process. These platinum splats are used as the electrical contacting points of the gas diffusion layer of an electrolyzer. FIG. 7 shows the SEM picture of the Pt dots on the porous Ti plate surface.

In another application, platinum-nickel alloy particles are deposited on a niobium substrate, in the form of Pt—Ni alloy splats, by a thermal spray process. These Pt—Ni alloy splats can be used as the electrical contact point of the niobium plate when it is used as the current collector of all-Vanadium redox batteries, where porous carbon felts are used as the electrode for electrode reactions.

In the applications where the metal plate is used as a current collector, it should be appreciated that it could be used as a bipolar plate; one side of the plate is in contact with positive electrode of one cell, and the other side of the plate is in contact with the negative electrode of the adjacent cell.

In another application where the metal plate is used as a current collector, it should be appreciated that it could be used as a mono-polar plate; i.e., the plate is only in contact with one electrode.

In one application the metal plate is used as the electrode in a zinc-bromine battery, whereby the polarity of the battery can be reversed in different charge/discharge cycles to electrochemically dissolve the “dead” zinc on the electrode and reactivate the battery. For example, electrode A is used as the positive electrode, and electrode B is used as the negative electrode in charge/discharge (C/D) cycles 1-50. Then, in C/D cycles 51-100, electrode A is used as the negative electrode, and electrode B is used as the positive electrode. Under the reverse polar operation mode, the “dead” zinc accumulated on electrode B can be dissolved into the electrolyte solution without the waste of its energy and the interruption of the battery operation. This reverse polar operation can be performed continuously through the life of the battery.

The C/D cycle times between each reverse polar operation is variable, determined by the battery operation conditions.

The reverse polar operation can be performed in soluble lead acid batteries, all iron batteries and other battery systems having at least one electrode reaction that is a liquid to solid conversion reaction. The electrode can also comprise other materials, such as graphite or conductive ceramics, in addition to metal.

In a large battery system with a number of batteries, the reverse polar operation can be performed on one battery at a time, to maintain the smooth operation of the whole system.

The various embodiments described above have been presented by way of example, and not limitation. It will be apparent to persons skilled in the art(s) that various changes in form and detail can be made therein without departing from the spirit and scope of the disclosure. In fact, after reading the above description, it will be apparent to one skilled in the relevant art(s) how to implement alternative embodiments. Thus, the disclosure should not be limited by any of the above-described exemplary embodiments.

Moreover, the methods and structures described above, like related methods and structures used in the electrochemical arts are complex in nature, are often best practiced by empirically determining the appropriate values of the operating parameters, or by conducting computer simulation to arrive at the best design for a given application. Accordingly, all suitable modifications, combinations, and equivalents should be considered as falling within the spirit and scope of the disclosure.

In addition, it should be understood that the figures are presented for example purposes only. The structures provided in the disclosure are sufficiently flexible and configurable, such that they may be formed and/or utilized in ways other than those shown in the accompanying figures.

What is claimed is:

1. A method of forming an electrode for a battery, said method comprising:
providing a metal substrate as the electrode body; and
depositing active point materials on a surface of the metal substrate to produce a plurality of splats on the surface of the metal substrate, the plurality of splats covering a portion of the surface of the metal substrate less than an entire surface of the metal substrate,
wherein the splats define active points for the electrode.

2. The method of claim 1, wherein the material used for the splats have a diameter of 0.005 μm to 50 μm.

3. The method of claim 1, wherein the splats comprise a precious metal or a precious metal alloy, and a diameter of the splats has a range of 5 nm-10 nm, 10 nm-50 nm, 10 nm-100 nm, 10 nm-20 μm, 1 nm-0.5 μm, 20 nm-0.5 μm, 100 nm-0.5 μm, 20 nm-1 μm, 100 nm1 μm, 0.5 μm-5 μm, 1 μm-20 μm, or 10 μm-50 μm.

4. The method of claim 1, wherein the distance between splats are between 0.05 μm to 500 μm.

5. The method of claim 1, wherein the splats comprise a precious metal or a precious metal alloy, and a distance between the splats is in the range of 50 nm-100 nm, 100 nm-20 μm, 0.1 μm-0.5 μm, 100 nm-1 μm, 1 μm-50 μm, 10 μm-200 μm- 100 μm-500 μm.

6. The method of claim 1, wherein the thickness associated with the splats is in the range of about 1 nanometer (nm) to about 50 microns (μm).

7. The method of claim 1, wherein the splats comprise a precious metal or a precious metal alloy, and a thickness of the splats is in the range of 1 nm-5 nm, 1 nm-10 nm, 10 nm-50 nm, 10 nm-100 nm, 10 nm-20 μm, 1 nm-0.5μm, 20 nm-0.5 μm, 100 nm-0.5 μm, 20 nm-1 μm, 100 nm-1 μm, 0.5 μm-5 μm, 1 μm-20 μm, 10 μm-50 μm.

8. The method of claim 1, wherein the battery is a lead acid battery, the metal substrate comprises titanium.

9. The method of claim 1, wherein the battery is an all iron battery, the metal substrate comprises titanium and the splats comprise one of gold, ruthenium or iridium.

10. The method of claim 1, wherein the battery is a zinc-halogen, the metal substrate comprises titanium and the splats comprise ruthenium.

11. The method of claim 10, wherein the titanium substrate comprises a mesh or screen.

12. The method of claim 10, wherein the titanium substrate comprises a titanium foil and said method further comprises forming the foil into a corrugated 3-D structure to allow battery solution to flow there-through.

13. A method of forming active points on a first substrate for a battery or an electrolyzer, said method comprising:
providing a titanium substrate as the first substrate; and
using a thermal spraying technique to deposit a precious metal or a precious metal alloy on a surface of the titanium substrate to produce a plurality of splats on the surface of the titanium substrate,
wherein the splats define the active points.

14. The method of claim 13, wherein the titanium substrate is a porous substrate, the titanium substrate with the plurality of splats forms an electrode for the battery.

15. The method of claim 14, wherein the precious metal or precious metal alloy comprises ruthenium.

16. The method of claim 14, wherein the titanium substrate comprises a mesh or screen.

17. The method of claim 13, wherein the titanium substrate comprises a titanium foil and said method further comprises forming the foil into a corrugated 3-D structure to allow battery solution to flow there-through.

18. The method of claim 13, wherein the titanium substrate with the plurality of splats forms a gas diffusion layer for the electrolyzer and the precious metal or precious metal alloy comprises platinum.

19. An electrode for a battery, said electrode comprising:
a titanium substrate, said substrate defining a body for the electrode; and
a plurality of thermally sprayed precious metal splats on the surface of the titanium substrate, the plurality of splats covering a portion of the surface of the titanium substrate less than an entire surface of the titanium,
wherein the splats define active points for the electrode.

20. The electrode of claim 19, wherein the titanium substrate comprises a mesh or screen.

21. The electrode of claim 19, wherein the titanium substrate comprises a titanium foil.

22. The electrode of claim 21, wherein the foil is formed as a corrugated 3-D structure to allow battery solution to flow there-through.
